(19) United States
(12) Patent Application Publication
(10) Pub. No.: US 2024/0281394 A1
(43) Pub. Date: Aug. 22, 2024

(54) PROCESSOR EVENT MANAGER

(71) Applicant: TEXAS INSTRUMENTS INCORPORATED, Dallas, TX (US)

(72) Inventor: Michael Zwerg, Dallas, TX (US)

(21) Appl. No.: 18/458,369

(22) Filed: Aug. 30, 2023

Related U.S. Application Data
(60) Provisional application No. 63/447,411, filed on Feb. 22, 2023.

(51) Int. Cl. G06F 13/28

(52) U.S. Cl. CPC G06F 13/28

(57) ABSTRACT

Various embodiments disclosed herein relate to an event manager for handling event notification and acknowledgement between circuits in a computing device. The event manager may be configured with static channels, direct memory access (DMA) channels, and dynamically configured channels. Each of the channels has conductors that allow a publishing circuit to assert a request signal on a conductor to notify the subscribing circuit of an event and the subscribing circuit to assert an acknowledge signal on a second conductor to notify the publishing circuit of receipt of the request signal. Using the request and acknowledge signals, the publishing circuit and subscribing circuit can engage in a 4-way handshake that ensures no events are lost and the events can be communicated reliably across clock domains.

### RELATED APPLICATIONS

This application hereby claims the benefit of and priority to U.S. Provisional Patent Application No. 63/447,411, entitled “PROCESSOR EVENT MANAGER,” filed Feb. 22, 2023, which is hereby incorporated by reference in its entirety for all purposes.

### TECHNICAL FIELD

This application relates generally to event managers within a processor and coordinating handshakes between circuits using an event manager.

### BACKGROUND

Many modern computing systems use events and event handling to coordinate activity. Events can include any occurrence or condition detected by a given portion of a computing system, and an event detected by a first portion of a computing system may be communicated to a second portion of the computing system for handling. A typical example of event handling may occur when interrupt requests (IRQ) are reported to the central processing unit (CPU). For example, when a user presses a key, linear program code execution is interrupted, and an interrupt service routine is processed. When complete, the linear program code continues execution. Another typical event scenario is a direct memory access (DMA) trigger. For example, a serial communication module may trigger a DMA transfer. Based on the trigger, the relevant data is moved from the serial communication module to the memory by the DMA module. Additionally, specific events involving communication between two modules or circuits may be another scenario. For example, a timer can generate a sample-trigger event to an analog-to-digital converter (ADC) to allow precise timely spaced ADC samples without latency jitter that is introduced by software-controlled triggers.

These exemplary event handling scenarios typically involve event connections that are predefined point-to-point connections that are implemented in a specific configuration for every system (e.g., processor, microcontroller, system-on-a-chip (SoC)). Additionally, once the event happens and the trigger occurs, it is common for there to be no follow up communication between the publisher (e.g., the timer) and the subscriber (e.g., the ADC).

These static configurations do not allow for flexibility in configuration. Further, when events happen in rapid succession, events can be lost if the subscriber has not handled the first event before a second event is triggered. Accordingly, a more flexible and robust solution is needed for event handling.

### SUMMARY

Disclosed herein is a configurable event manager. The event manager configures event handling channels between publishing circuits and subscriber circuits. Some of the channels are generic channels. For generic channels on startup, for example, the event manager may configure the available channels to include conductors for transmitting request and acknowledge signals between corresponding publishers and subscribers. Some of the channels may be static channels for specific publishers and subscribers that may, for example, require a static channel having conductors for interrupt signals and acknowledgement signals. Some of the channels may be for direct memory access (DMA) circuits. The DMA channels may include additional conductors for transmitting a count of memory transactions, a status of the processing, and so forth as described in more detail throughout this disclosure. All of the channels are used by the publishers and subscribers during runtime of the system to ensure efficient event handling. For example, the publishers and subscribers use the channels to perform handshaking to ensure the events are handled and not lost.

In some embodiments, a system can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a device that includes an event manager coupled between a first circuit and a second circuit, the event manager may include an event channel including at least two conductors between the first circuit and the second circuit. The first conductor may be configured to transmit a request signal from the first circuit to the second circuit. The second conductor may be configured to transmit an acknowledge signal from the second circuit to the first circuit. The device also includes the first circuit configured to assert the request signal on the first conductor of the event channel based on detecting an event. The first circuit is also configured to, in response to detecting an assertion of the acknowledge signal, de-assert the request signal. The device also includes the second circuit configured to in response to detecting the assertion of the request signal, assert the acknowledge signal on the second conductor of the event channel, and in response to detecting the de-assertion of the request signal, de-assert the acknowledge signal.

Implementations may include one or more of the following features. In some embodiments, the second circuit is further configured to begin processing a second event associated with the request signal. The event channel further may include a third conductor between the first circuit and the second circuit configured to transmit a completion signal from the second circuit to the first circuit and a fourth conductor between the first circuit and the second circuit configured to transmit a done acknowledge signal from the first circuit to the second circuit. The second circuit may further be configured to, in response to completion of the processing of the second event, assert the completion signal on the third conductor of the event channel, and in response to detecting an assertion of the done acknowledge signal, de-assert the completion signal. The first circuit may further be configured to, in response to detecting the assertion of the completion signal, assert the done acknowledge signal on the fourth conductor of the event channel, and in response to detecting the de-assertion of the completion signal, de-assert the done acknowledge signal.

In some embodiments, the event channel further may include a third conductor between the first circuit and the second circuit configured to transmit a count of a number of direct memory access (DMA) transactions associated with the request signal. The first circuit may further be configured to transmit the count of the number of DMA transactions associated with the request signal on the third conductor of the event channel. The second circuit may further be configured to, in response to detecting the assertion of the request signal and the count, begin processing the number of DMA transactions indicated by the count. In some embodiments, the event channel further may include a fourth conductor between the first circuit and the second circuit configured to transmit a completion signal from the second circuit to the first circuit and a fifth conductor between the first circuit and the second circuit configured to transmit a done acknowledge signal from the first circuit to the second circuit. The second circuit may further be configured to, in response to completion of the processing of the number of the DMA transactions, assert the completion signal on the fourth conductor of the event channel and in response to detecting an assertion of the done acknowledge signal, de-assert the completion signal. The first circuit may further be configured to, in response to detecting the assertion of the completion signal, assert the done acknowledge signal on the fifth conductor of the event channel and in response to detecting the de-assertion of the completion signal, de-assert the done acknowledge signal. In some embodiments, the event channel further may include a sixth conductor between the first circuit and the second circuit configured to indicate a status of completion of the processing of the number of the DMA transactions. The second circuit may further be configured to, in response to completion of the processing of the number of the DMA transactions, assert a done status signal on the sixth conductor of the event channel and in response to de-asserting the completion signal, de-assert the done status signal.

In some embodiments, the first circuit may be configured to detect an event prior to detecting the assertion of the acknowledge signal on the second conductor of the event channel and to generate a second request signal based on detecting the event. The first circuit may be configured to store information for generating the second request signal in a queue, and in response to detecting the assertion of the acknowledge signal and de-asserting the request signal on the second conductor of the event channel, assert the second request signal on the first conductor of the event channel.

In some embodiments, the processing device may include a wakeup circuit coupled to the second circuit and configured to enable the second circuit from a sleep state to an enabled state that allows the second circuit to detect the assertion of the interrupt signal in response to detecting the assertion of the interrupt signal on the interrupt channel.

In some embodiments, the event manager may split the first conductor of the event channel to couple the first circuit to the second circuit and to a third circuit. The event channel further may include a third conductor between the first circuit and the third circuit configured to transmit a second acknowledge signal from the third circuit to the first circuit. The third circuit may be configured to assert, on the third conductor of the event channel, the second acknowledge signal in response to detecting the assertion of the request signal on the first conductor of the event channel. The first circuit may further be configured such that de-asserting the request signal is further in response to detecting both the acknowledge signal from the second circuit and the second acknowledge signal from the third circuit.

In some embodiments, the event manager may be configured to dynamically assign each event channel between one publishing circuit and an associated subscribing circuit (e.g., the event channel is configured and dynamically assigned between the first circuit and the second circuit). Implementations of the described techniques and processing device may include hardware, a method or process, computer software on a computer-accessible medium, or a combination.

Another general aspect includes a method. The method may be described as a four-way handshake between a publishing circuit (e.g., the first circuit) and a subscribing circuit (e.g., the second circuit) to ensure, for example, all events are handled. The method may include asserting, by a first circuit on a first conductor of an event channel between the first circuit and a second circuit, a request signal. In response to detecting the assertion of the request signal, asserting, by the second circuit on a second conductor of the event channel, an acknowledge signal. In response to detecting the assertion of the acknowledge signal, de-asserting, by the first circuit, the request signal. In response to detecting the de-assertion of the request signal, de-asserting, by the second circuit, the acknowledge signal. Other embodiments of this aspect may include corresponding computer systems, apparatus, and computer programs recorded on one or more computer storage devices, each configured to perform the actions of the methods.

Implementations may include one or more of the following features. In some embodiments, the method may include in response to detecting the assertion of the request signal, beginning, by the second circuit, processing an event associated with the request signal. In some embodiments, the method may further include in response to completion of the processing of the event associated with the request signal, asserting, by the second circuit on a third conductor of the event channel, a completion signal. In response to detecting the assertion of the completion signal, asserting, by the first circuit on a fourth conductor of the event channel, a done acknowledge signal. In response to detecting the assertion of the of the done acknowledge signal, de-asserting, by the second circuit, the completion signal on the third conductor of the event channel. In response to detecting the de-assertion of the completion signal, de-asserting, by the first circuit, the done acknowledge signal on the fourth conductor of the event channel.

In some embodiments, the method may include transmitting, by the first circuit, a count of a number of direct memory access (DMA) transactions associated with the request signal on a third conductor of the event channel. In response to detecting the assertion of the request signal on the first conductor and the count on the third conductor, beginning, by the second circuit, processing the number of the DMA transactions indicated by the count. In some embodiments, the method may further include in response to completion of the processing of the number of the DMA transactions, asserting, by the second circuit on a fourth conductor of the event channel, a completion signal. In response to detecting the assertion of the completion signal, asserting, by the first circuit on a fifth conductor of the event channel, a done acknowledge signal. In response to detecting the assertion of the of the done acknowledge signal, de-asserting, by the second circuit, the completion signal on the fourth conductor of the event channel. In response to detecting the de-assertion of the completion signal, de-asserting, by the first circuit, the done acknowledge signal on the fifth conductor of the event channel. In some embodiments, the method may include asserting, by the second circuit on a sixth conductor of the event channel, a done status signal in response to completion of the processing of the number of the DMA transactions, and de-asserting, by the second circuit on the sixth conductor of the event channel, the done status signal in response to de-asserting the completion signal.

In some embodiments, the method may further include detecting, by the first circuit, an event configured to generate a second request signal prior to detecting the assertion of the acknowledge signal. The first circuit may store information for generating the second request signal in a queue, and in response to detecting the assertion of the acknowledge signal on the second conductor of the event channel and de-asserting the request signal on the first conductor of the event channel, asserting, by the first circuit, the second request signal on the first conductor of the event channel.

In some embodiments the method may include configuring the event channel between the first circuit and the second circuit via an event manager.

In some embodiments, the second circuit is in a sleep state, and the method may include in response to detecting the assertion of the request signal on the first conductor of the event channel, enabling, by a wakeup circuit associated with the second circuit, the second circuit from the sleep state to an enabled state that allows the second circuit to detect the assertion of the request signal.

In some embodiments, the event channel is split to couple the first circuit to the second circuit and a third circuit, and the method may include in response to detecting the assertion of the request signal on the first conductor of the event channel, asserting, by the third circuit on a third conductor of the event channel between the first circuit and the third circuit, a second acknowledge signal. The first circuit de-asserting the request signal on the first conductor of the event channel may further be in response to detecting both the acknowledge signal from the second circuit and the second acknowledge signal from the third circuit. Implementations of the described techniques may include hardware, a method or process, or computer software on a computer-accessible medium.

This Summary is provided to introduce a selection of concepts in a simplified form that are further described below in the Detailed Description. It may be understood that this Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an exemplary system including an event manager, according to some embodiments.

FIG. 2 illustrates another exemplary system including dynamically configurable event channels in an event manager, according to some embodiments.

FIG. 3 illustrates another exemplary system including an event manager configured with direct memory access (DMA) channels, according to some embodiments.

FIG. 4 illustrates another exemplary system including an event manager configured with static channels, according to some embodiments.

FIG. 5 illustrates an exemplary graph depicting the clock and signals transmitted across an event channel for executing a four-way handshake, according to some embodiments.

FIG. 6 illustrates an exemplary graph depicting the clock and signals transmitted across an event channel for executing DMA event four-way handshakes and count transmission, according to some embodiments.

FIG. 7 illustrates a method of executing a four-way event handshake, according to some embodiments.

FIG. 8 illustrates a method of executing a portion of DMA event four-way handshakes, according to some embodiments.

FIG. 9 illustrates a system for generic channel dynamic configuration by an event manager, according to some embodiments.

FIG. 10 illustrates a system for generic channel locking during dynamic configuration by an event manager, according to some embodiments.

FIG. 11 illustrates reuse models for using an event manager, according to some embodiments.

FIG. 12 illustrates a system and graph depicting event splitting and the associated signals across an event channel in an event manager, according to some embodiments.

FIG. 13 illustrates event synchronization across domains, according to some embodiments.

FIG. 14 illustrates a graph depicting the clock and signals transmitted across an event channel for wakeup of a circuit based on an event, according to some embodiments.

The drawings are not necessarily drawn to scale. In the drawings, like reference numerals designate corresponding parts throughout the several views. In some embodiments, components or operations may be separated into different blocks or may be combined into a single block.

### DETAILED DESCRIPTION

Discussed herein are enhanced components, techniques, and systems related to processor event management. Specifically, a configurable event manager can manage transmission of events between a publishing component and a subscribing component.

Modern computing systems are capable of event handling, however, known event handling is static and prone to lost events as discussed above. Events including interrupt requests provided to a central processing unit (CPU), direct memory access DMA triggers, and other triggers to indicate general events between circuits may all be handled in a computing system. The description herein includes a flexible event manager that can dynamically assign event channels between circuits and allows for four-way handshaking to avoid event loss, which results in a flexible yet robust event handling system.

The event manager is a framework of circuits that implement generic, flexible, and robust event handling inside a processing system. The event manager can be configured to handle CPU interrupts, DMA triggers, and other circuit-to-circuit triggers for event notification. The event manager defines the event protocol, the publisher (event generating circuit), the subscriber (event consuming circuit), and the routing between the publisher and subscriber. It further defines a method of transferring events across clock domains, configuring an event route between arbitrary circuits, and a four-way handshake protocol to ensure events are handled despite rapid succession of events.

For example, in some alternative level triggered event systems (e.g., those where interrupts are provided to the CPU), the event generating circuit will assert an event line and keep the event line asserted until the CPU clears the event. While this type of event system works across clock domains, it involves CPU interaction to clear the event, which makes it unsuitable for circuit-to-circuit events like DMA triggers. In existing edge triggered event systems (e.g., ADC or DMA triggers), the event generating circuit will assert an event line for one or multiple clock cycles and then de-assert the event line automatically. This can cause issues across clock domains depending on clock speed differences, and the receiving circuit may not recognize or catch the event edge signaling a new event, causing lost events. Further, in existing systems, if more than one event is indicated (e.g., multiple triggers for an ADC), a local multiplexer on the event subscriber/receiving side may select which event to take. The connectivity and availability of the event on the receiving circuit is defined during the system on a chip (SoC) creation process, which only captures a subset of the available options and is not dynamically modified. The available multiplexer options are captured in a datasheet and might change from one SoC to the next but cannot be changed once the SoC is created.

As described herein, the event manager resolves the above-described issues. The event manager configures channels having at least two conductors to communicate between the publisher and the subscriber. In an example, there is an event request (REQ) signal from the publisher to the subscriber circuit on one conductor and an event acknowledge (ACK) signal from the subscriber to the publisher on another conductor. In case of an event, the publisher asserts the REQ-signal (i.e., request signal) and waits for the subscriber to acknowledge the event by asserting the ACK-signal (e.g., acknowledge signal). Once the publisher sees the ACK-signal asserted, it will de-assert the REQ-signal and wait for the subscriber to de-assert the ACK-signal. This back-and-forth creates the four-way handshake protocol that ensures events are not lost. The four-way handshake provides an improvement over existing systems because it can be used for any event (CPU interrupt, DMA trigger, circuit-to-circuit trigger). Further, it is agnostic to differences in clock frequency between the publisher circuit and the subscriber circuit. No matter which clock is faster, the faster side will wait until the slower side changes the signal (i.e., asserts or de-asserts the signal). Additional synchronizer pipeline flops inserted into the REQ or ACK (request or acknowledge) signal will not change the protocol, and the transfer of a single event is assured. Further, since the four-way handshake delivers an acknowledge signal back to the publisher, the publisher can clear the event source on arrival of the ACK-signal, which allows use in circuit-to-circuit events without CPU interaction.

The event manager may define configuration of splitting an event from one publisher to two or more subscribers. Each SoC implementation has a given number of channels. Small SoCs may have fewer channels (e.g., three-channel), and large SoCs may have more (e.g., 31-channel). The number of channels defines how many point-to-point connections can exist at any time. The event manager can assign the publisher and subscriber to the same channel, and only one publisher will be assigned to a channel at any given time. More subscribers can be assigned to each channel, though hardware or other limitations may limit each channel to two subscribers. In this dynamically configurable system, any publisher can connect to any subscriber if trigger options change, which was not found in many alternative systems.

The event manager offers another advantage as a wakeup controller since the event manager is aware of events that transfer between the publishers and subscribers, the event manager can wake the subscriber from, for example, a low- or no-power mode to react to the event. In prior systems, the receiving circuit had to be awake to receive events or had to implement its own wakeup controller.

The event manager may further implement side band signals for DMA trigger events including count information, done acknowledgement for notifying of completion of DMA processing of the event, and status information.

These enhancements substantially improve the functioning of the computing system. Events are handled without loss due to the four-way handshake protocol. Further, fewer or no CPU cycles are consumed by clearing event signals when they are circuit-to-circuit or DMA transfer events. The dynamic configuration of the publisher-to-subscriber channels further allows for changes in the system without hardware or firmware revisions.

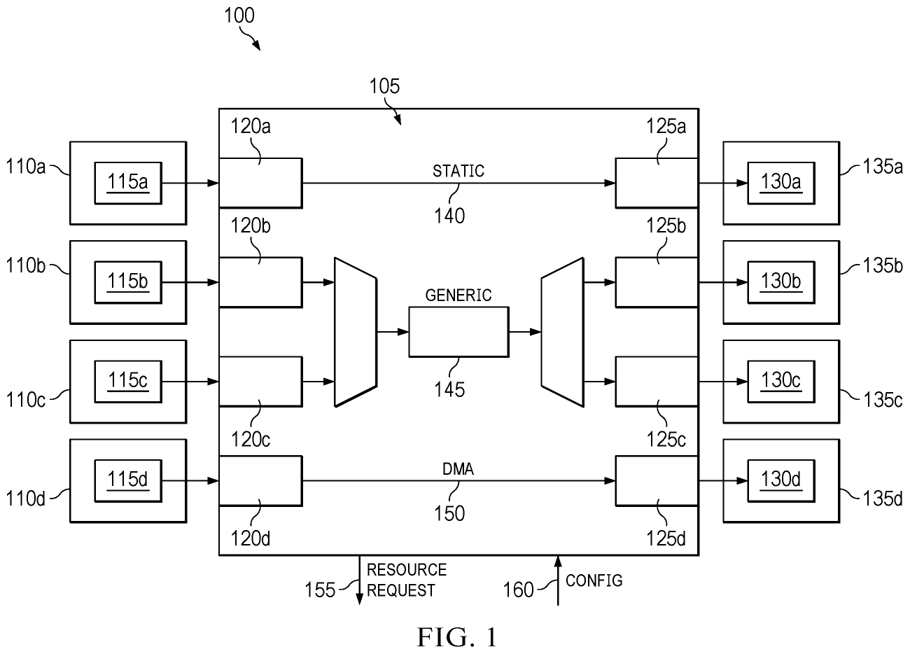

Turning to the figures, FIG. 1 illustrates system 100. System 100 may be implemented in a computing device that includes, for example, a central processing unit (CPU) and memory, which are not shown for ease of description. The CPU (e.g., one or more processors or a processing unit) may process instructions stored in the memory that cause the CPU to perform tasks. System 100 may include publishing circuits 110a, 110b, 110c, and 110d (collectively 110), publishing components 115a, 115b, 115c, and 115d (collectively 115), event manager publisher connections 120a, 120b, 120c, and 120d (collectively 120), event manager 105, event manager subscriber connections 125a, 125b, 125c, and 125d (collectively 125), subscribing components 130a, 130b, 130c, and 130d (collectively 130), and subscribing circuits 135a, 135b, 135c, and 135d (collectively 135).

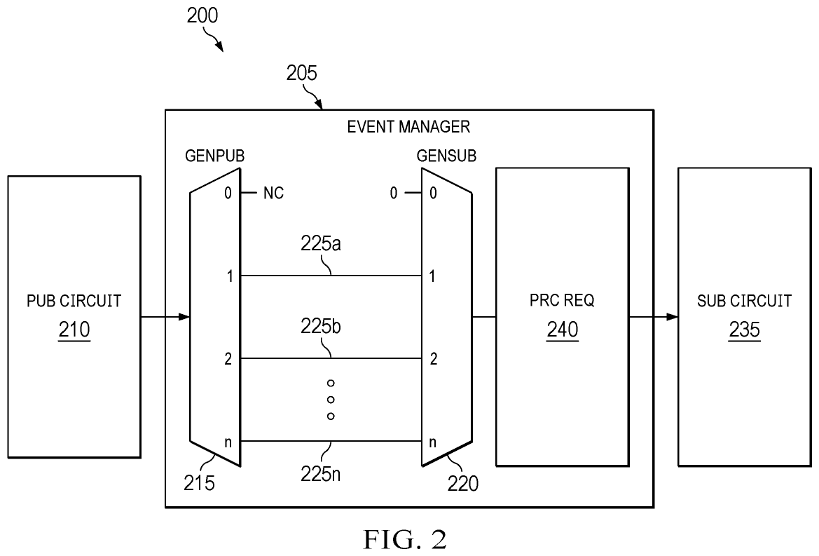

Event manager 105 includes static channels 140, generic channels 145, and DMA channels 150 (referred to generically herein as event channels). Further details of each type of channel and the configurations of each are provided in FIGS. 2-4. While not shown in detail in FIG. 1, static channel 140, generic channel 145, and DMA channel 150 each include at least two conductors such that one conductor is for asserting the request signal (e.g., REQ-signal, interrupt signal, or trigger signal) by the publishing circuit 110 to notify the subscribing circuit 135 of the event, and the second conductor is for asserting the acknowledge (e.g., ACK-signal) by the subscribing circuit 135 to notify the publishing circuit 110 that the request signal was detected and is acknowledged. These two channels are used for the four-way handshake that is discussed in more detail throughout.

On the publishing side of event manager 105 is event manager publisher connections 120. On the subscribing side of event manager 105 is event manager subscriber connections 125. The event manager publisher connections 120 provide a connection for a corresponding publishing component 115 and the event manager subscriber connections 125 provide a connection for a corresponding subscribing component 130, which are connected to each other in the event manager via an event channel. As one example, publishing circuit 110a includes a publishing component 115a that includes the information necessary to communicate with publisher connection 120a. On the subscribing side, subscribing circuit 135a includes subscribing component 130a that includes the information to communicate with subscriber connection 125a. Subscriber connection 125a is coupled to publisher connection 120a via static channel 140. Publishing circuit 110a may be a circuit that triggers a CPU interrupt in some embodiments. For example, publishing circuit 110a may recognize a keyboard stroke by a user to trigger a CPU interrupt. The subscribing circuit 135a may be a CPU interrupt connection to the CPU. When, for example, the publishing circuit 110a recognizes a keyboard stroke, the publishing circuit 110a uses publishing component 115a to communicate with publisher connection 120a to assert a request signal on a first conductor of static channel 140. Subscriber connection 125a recognizes the assertion of the request signal and communicates the assertion of the request signal to subscribing circuit 135a via subscribing component 130a. Similar configurations are used to communicate request signals from publishing circuit 110b via a generic channel 145 to subscribing circuit 135b, publishing circuit 110c via the generic channel 145 to subscribing circuit 135c, and publishing circuit 110d via the DMA channel 150 to subscribing circuit 135d.

As shown in FIG. 1, static channel 140 and DMA channel 150 may be fixed point-to-point connections that are not dynamically changeable in some embodiments. Generic channels 145 may be dynamically configured point-to-point connections as described in more detail with respect to FIGS. 2, 9, 10, and 12. The dynamic configuration information may come from configuration information 160 that can be changed by software during runtime. Resource requests 155 may be made by the event manager 105 to wake up a system from low power mode when an event is detected, and a request signal is transmitted via the event manager from the publishing circuit 110.

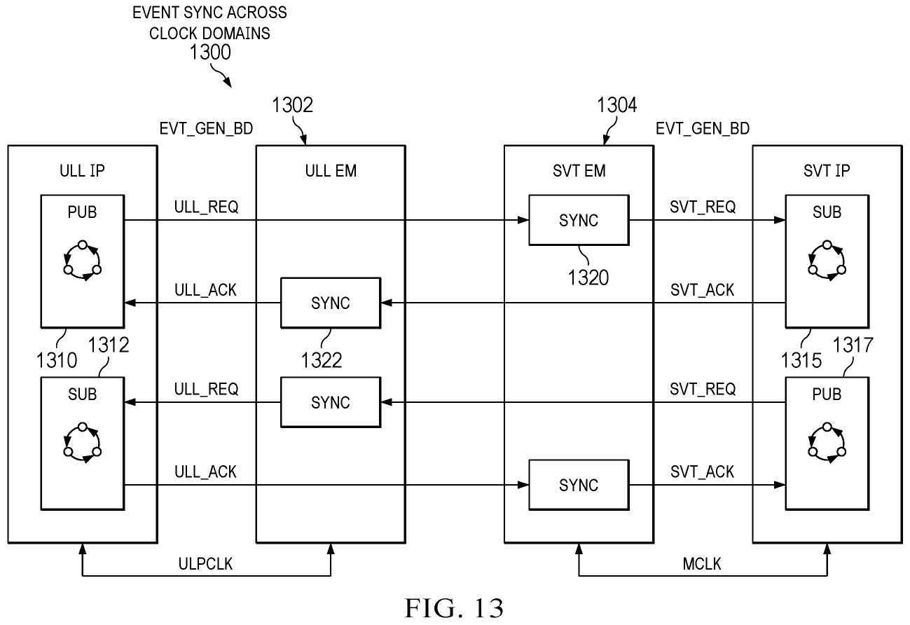

Publishing circuits 110 may be any circuit that provides notification of an event for handling by a subscriber. Publishing circuits 110 may each be implemented as separate circuits in system 100, or in any other implementation that allows for connecting to the channels 140, 145, 150 of event manager 105. Subscribing circuits 135 may be any circuit that handles an event (e.g., takes an action in response to the event) upon notification by a publishing circuit 110. The subscribing circuits 135 may each be implemented as a separate circuit or sub-chip from other circuits in system 100, or in any other implementation that allows for connecting to channels 140, 145, 150 of event manager 105. In some embodiments, one or more of any of publishing circuits 110 or any of subscribing circuits 135 may be another event manager, for example, in a different clock domain. For example, subscribing circuit 135c may be another event manager, or publishing circuit 110d may be a different event manager. The details of such configuration are shown in more detail with respect to FIG. 13. In some embodiments, publishing circuits 110 may also function as subscribing circuits 135 and vice versa depending on the event. For example, publishing circuit 110b may be the same circuit as subscribing circuit 135d because for some events it is the publishing circuit for notifying of the event for handling with a request signal and for other events it is the subscribing circuit for handling the event.

As examples, publishing circuit 110a may be a circuit that recognizes user inputs via peripheral devices such as keyboards, touchscreens, a mouse, or any other input device. The corresponding CPU interrupt signal may be configured via a static channel 140 for notifying the CPU via the subscribing circuit 135a which may be the CPU or a CPU interrupt input. Publishing circuits 110b and 110c may be any circuit-to-circuit event publishers. For example, publishing circuit 110b may be a timer that generates a request signal transmitted via publishing component 115b to publisher connection 120b to assert the request signal on a conductor of generic channel 145 to which subscriber connection 125b may expose to subscribing component 130b so that subscribing circuit 135b may handle the event. Subscribing circuit 135b may be an ADC, for example. Publishing circuit 110d may be a serial communication module that may trigger a DMA transfer. When the publishing circuit 110d triggers the request signal, publishing component 115d transmits the information to publisher connection 120d to assert the request signal on a conductor of DMA channel 150. Subscriber connection 125d transmits the assertion information to the subscribing component 130d, and the subscribing circuit 135d can handle the DMA trigger. Subscribing circuit 135d may be a DMA module that, based on the assert, moves data from publishing circuit 110d (e.g., the serial communication module) to memory (not shown).

Advantageously, and as discussed in further detail herein, event manager 105 may handle fixed point-to-point event channels such as static channels 140 and DMA channels 150 as well as dynamic point-to-point event channels 145. Publishing circuits 110 may be any type of publishing circuits that transmit signals based on events for handling including events for CPU handling, DMA transfers, and circuit-to-circuit event handling. Further, the four-way handshake that is used through the configured channels ensures all events are handled for any type of channel and even across clock domains.

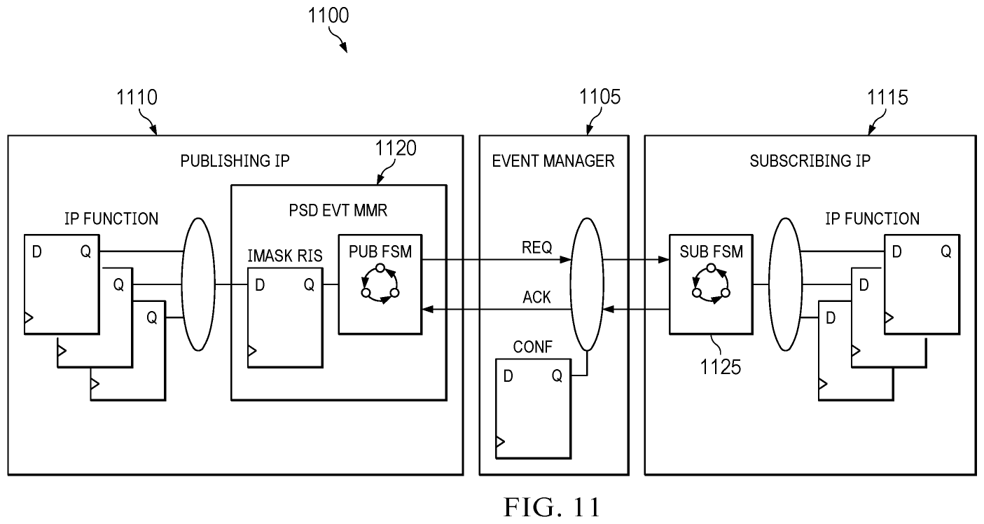

FIG. 2 illustrates exemplary system 200 including an event manager 205 with dynamically configurable event channels 225. Event manager 205 may be substantially the same as event manager 105 but is shown in more detail to describe generic channels and dynamic channel configuration. System 200 may include publishing circuit 210, event manager 205, and subscribing circuit 235. The connection components including publishing component (e.g., publishing component 115b), publisher connection (e.g., publisher connection 120b), subscriber connection (e.g., subscriber connection 125b), and subscribing component (e.g., subscribing component 130b) are not shown in FIG. 2. However, a connection interface in the publishing and subscribing circuits may be used to interface with the event manager, and a reuse module is described in more detail with respect to FIG. 11 for ease of incorporating such interface.

Publishing circuit 210 may be substantially the same as any of publishing circuits 110b or 110c as described with respect to FIG. 1. Publishing circuit 210 may, in some embodiments, be another event manager. The details of such configuration are shown in more detail with respect to FIG. 13. While only one publishing circuit 210 is depicted for ease of description, there may be any number of publishing circuits 210, which are limited only by the number of event channels in event manager 205.

Subscribing circuit 235 may be substantially the same as any of subscribing circuits 135b or 135c as described with respect to FIG. 1. Subscribing circuit 235 may, in some embodiments, be another event manager. The details of such configuration are shown in more detail with respect to FIG. 13. While only one subscribing circuit 235 is depicted for ease of description, there may be any number of subscribing circuits 235, which are limited only by the number of event channels in event manager 205.

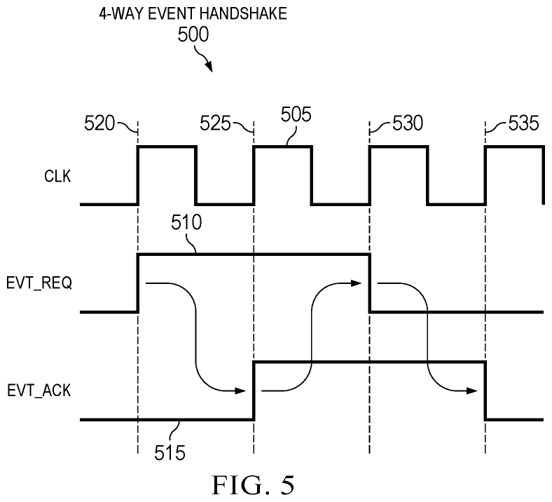

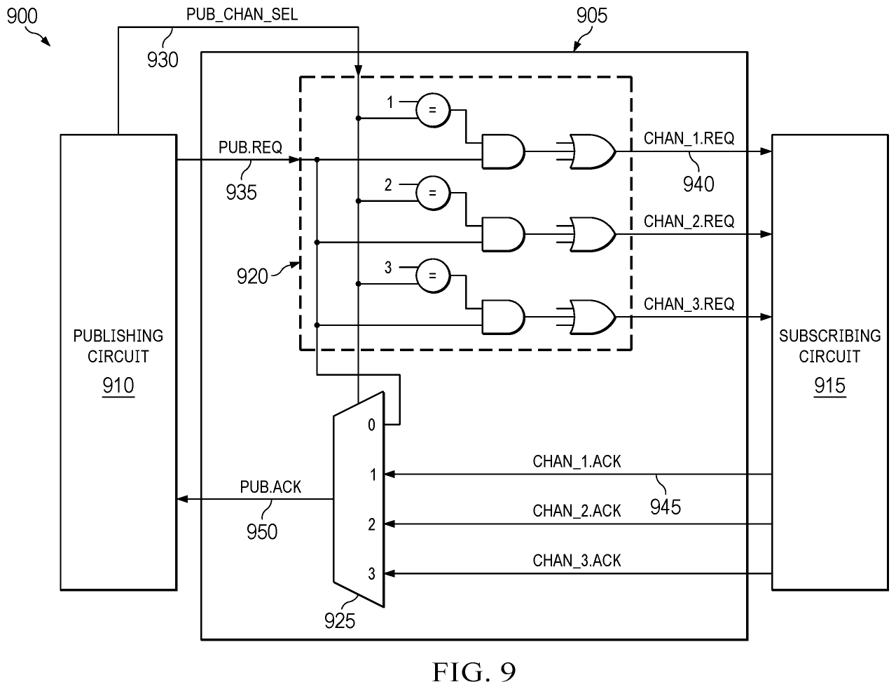

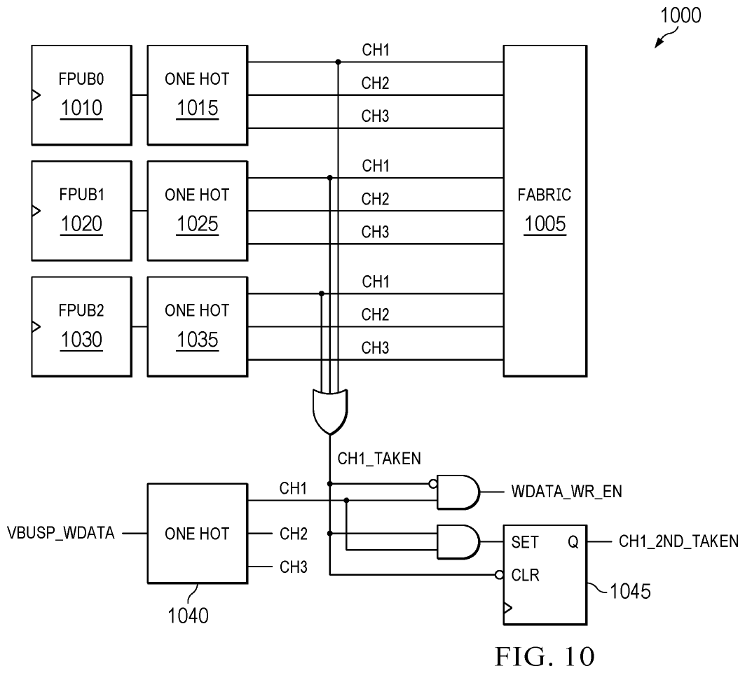

Event manager 205 shows a publishing side multiplexer 215 and a subscribing side multiplexer 220. The publishing side multiplexer 215 may be a distributed multiplexer that is coupled to a set of publishing circuits 210 and to a set of channels 225 and selectably couples the publishing circuits 210 to the channels 225 such that each publishing circuit 210 may be communicatively coupled to any given channel 225 at a given time. Thus, multiplexer 215 distributes the signal from each publishing circuit 210 to the correct channel. During use, the distributed multiplexer (publishing side multiplexer 215) may gate multiple inputs with an AND function and use an OR function on all channel outputs from the distributed multiplexer to ensure only one channel is active at a time. Additional details of how a distributed multiplexer may be used are described with respect to FIG. 9. To couple a publishing circuit with a subscribing circuit, the publisher channel identifier matches the subscriber channel identifier. Additional details of how channels 225 are dynamically configured are described with respect to FIG. 10. The subscribing side multiplexer 220 may be a standard (not distributed) multiplexer that ensures the signal from each publishing circuit 210 is routed to the correct subscribing circuit 235 and the acknowledge from each subscribing circuit 235 is routed back to the correct publishing circuit 210. Each signal (e.g., request or acknowledge) is transmitted across a conductor of the channel. The initial request signal and corresponding acknowledge signals are used for a four-way handshake that ensures no events are lost or go unhandled. Channels 225a, 225b, and 225n are channels that may be used in event manager 205. There are “n” channels, indicating that any number of channels may be available for configuration based on the hardware of system 200. Further, channels 225a, 225b, and 225n include bi-directional signal communication on separate conductors, so each channel 225 includes at least two conductors, one for the request signal and one for the acknowledge signal. For example, channel 225a includes an input and output on each side so that when publishing circuit 210 asserts the request signal on a first conductor of channel 1 225a, subscribing circuit 235 can detect the assertion. Subscribing circuit 235 can assert an acknowledge signal on a second conductor of channel 1 225a via the input on the subscribing side, and publishing circuit 210 can detect the acknowledge. The ability to assert a signal in each direction on a single channel is used for the four-way handshake discussed in more detail with respect to FIGS. 5, 6, and 14.

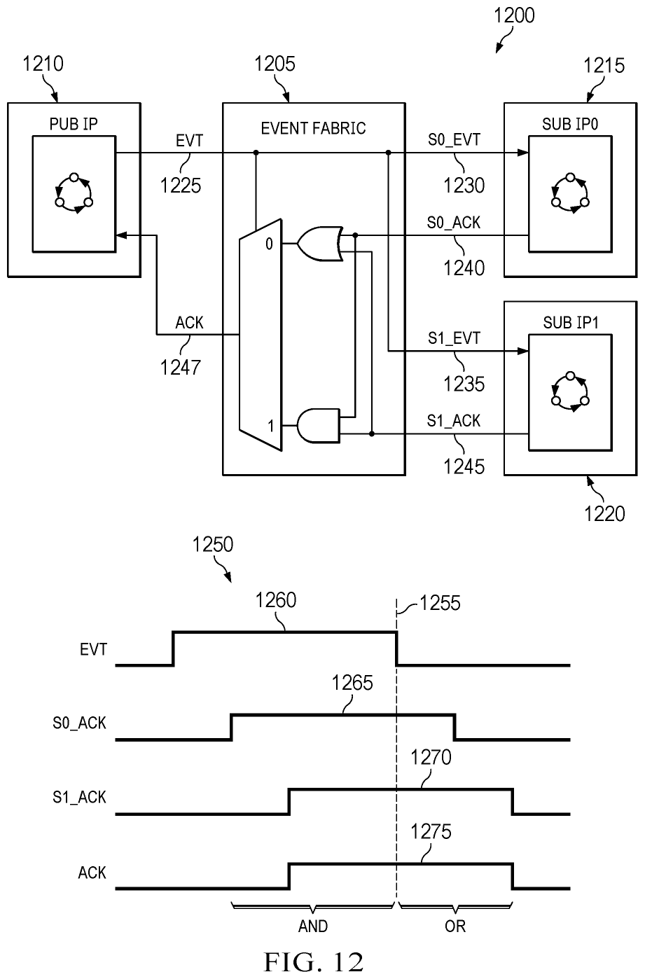

Publishing circuit 210 signals event manager 205 with a publisher channel identifier (e.g., channel 1), and subscribing circuit 235 signals event manager 205 with a subscriber channel identifier (e.g., channel 1). An event connection is made when the publisher channel identifier matches the subscriber channel identifier. A single channel connection allows one point-to-point connection. A dual channel connection allows two subscribers to be assigned to one publisher, which is the event splitting described in more detail with respect to FIG. 12.

In use, for example, when system 200 starts up, publishing circuit 210 is initialized and may select channel 1 225a for communicating a request signal (i.e., trigger signal) when a particular event happens. Subscribing circuit 235 also selects channel 1 225a to receive the request signal from the publishing circuit 210. As one example, publishing circuit 210 may be a timer and subscribing circuit 235 may be an ADC that samples a temperature sensor. The configuration may be to ensure the ADC samples every millisecond, so the timer (publishing circuit 210) will use channel 1 225a to send a request signal every millisecond, and the ADC (subscribing circuit 235) will subscribe to channel 1 225a and upon receiving the request signal will perform the sampling. Dynamic channel selection is discussed in more detail with respect to FIGS. 9 and 10.

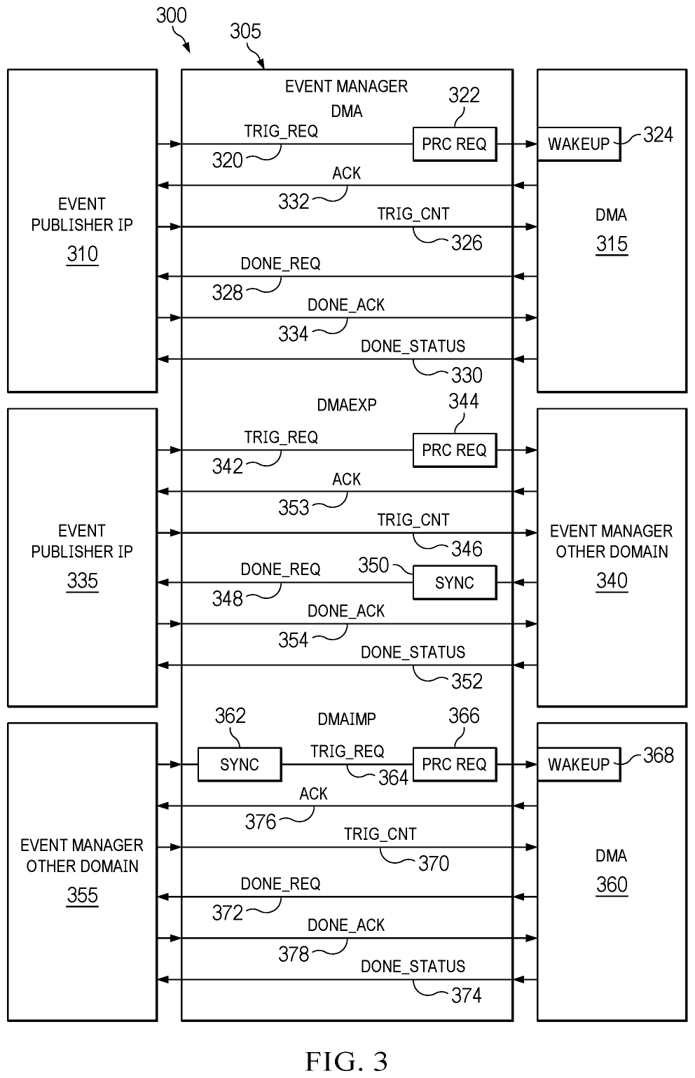

FIG. 3 illustrates exemplary system 300 including event manager 305. Event manager 305 may be substantially the same as event manager 105 but is shown in detail to describe direct memory access (DMA) channels.

System 300 includes publishing circuit 310, publishing circuit 335, publishing event manager 355, event manager 305, subscribing DMA circuit 315, subscribing event manager 340, and subscribing DMA circuit 360.

Publishing circuit 310 may be any circuit that issues a trigger signal (i.e., request signal) indicating a DMA transfer is requested. For example, publishing circuit 310 may be a serial communication module. Subscribing DMA circuit 315 may be any subscribing DMA circuit that may handle the event associated with the signal from the publishing circuit 310, such as a DMA module that can move data from, for example, the publishing circuit 310 to a memory location within system 300. Event manager 305 provides a point-to-point channel between publishing circuit 310 and subscribing DMA circuit 315 with multiple conductors for transmitting a number of signals relevant to a DMA transfer. Each conductor transmits a different type of signal. For example, request conductor 320 transmits request signals, acknowledge conductor 332 transmits acknowledge signals, count conductor 326 transmits count signals, and status conductor 330 transmits status signals. The channel and conductors may be static channels configured during manufacturing. A first event channel is configured to couple publishing circuit 310 and subscribing DMA circuit 315. The event channel includes a number of conductors including a request conductor 320, a corresponding acknowledge conductor 332, a count conductor 326, a done request conductor 328, a corresponding done acknowledge conductor 334, and a done status conductor 330. Request conductor 320 allows publishing circuit 310 to assert the request signal, indicating the event and that the subscribing DMA circuit 315 is designated to handle the event. Acknowledge conductor 332 allows subscribing DMA circuit 315 to acknowledge detection of the request signal by asserting an acknowledge signal. Request conductor 320 and acknowledge conductor 332 allow for independent communication in both directions, which allows subscribing DMA circuit 315 to acknowledge the request signal issued by publishing circuit 310 to complete the four-way handshake. In other words, publishing circuit 310 can assert the request signal at the input on the publishing side of request conductor 320. Subscribing DMA circuit 315 can detect the assertion of the request signal at the output on the subscribing side of request conductor 320. In response, subscribing DMA circuit 315 can assert an acknowledge signal at the input on the subscribing side of acknowledge conductor 332, and publishing circuit 310 can detect the acknowledge signal at the output on the publishing side of acknowledge conductor 332. Accordingly, each request conductor 320, 328, 342, 348, 364, and 372 has a corresponding acknowledge conductor 332, 334, 353, 354, 376, and 378, respectively.

There is also a count conductor 326, done request conductor 328, and done acknowledge conductor 334, and status conductor 330 between publishing circuit 310 and subscribing DMA circuit 315. Count conductor 326 allows publishing circuit 310 to indicate the number of DMA transactions for subscribing DMA circuit 315 to perform associated with the request signal. Done request conductor 328 is used by subscribing DMA circuit 315 to notify publishing circuit 310 that the DMA transactions associated with the request signal are complete. In the same way described above with respect to request conductor 320, publishing circuit 310 can acknowledge the done request signal on done acknowledge conductor 334. Status conductor 330 is used by subscribing DMA circuit 315 to provide status information to publishing circuit 310 about the DMA transfer.

Subscribing circuit 315 includes wakeup circuit 324. Wakeup circuit 324 can be separate from or a portion of subscribing DMA circuit 315 that can wake DMA circuit 315 if it is in a low- or no-power mode. Event manager 305 can use request conductor 320 to issue a power reset clock (PRC) request 322, which is a logical construction in FIG. 3 used to illustrate that the assertion of the request signal on request conductor 320 may trigger a PRC request to wakeup circuit 324. Wakeup circuit 324 can wake (e.g., power up) subscribing DMA circuit 315.

In use, the event that publishing circuit 310 is intended to identify may occur. Publishing circuit 310 asserts the request signal on request conductor 320 and may provide, via count conductor 326, a count of the number of DMA transactions to be completed by subscribing DMA circuit 315 based on the event, for example. A PRC request 322 issues to wakeup circuit 324, and wakeup circuit 324 wakes subscribing DMA circuit 315. Subscribing DMA circuit 315 detects the assertion of the request signal and, in response, asserts the acknowledge signal on the acknowledge conductor 332 as well as begins processing the event, using any count information provided via the count conductor 326. The behavior of handling the event is part of the subscribing DMA circuit 315 as it is configured or programmed to move data in response to the request signal. When publishing circuit 310 detects the assertion of the acknowledge signal on the acknowledge conductor 332, it may de-assert the request signal. When subscribing DMA circuit 315 detects the request signal de-assertion, it can de-assert the acknowledge signal. When subscribing DMA circuit 315 is done processing the DMA transactions, subscribing DMA circuit 315 asserts a completion signal on the done request conductor 328, and publishing circuit 310 can, upon detecting the assertion of the completion signal, assert a done acknowledge signal on the corresponding done acknowledge conductor 334. During processing of the DMA transfers, subscribing DMA circuit 315 may provide a done status signal on status conductor 330 as well. When subscribing DMA circuit 315 detects the assertion of the acknowledge signal on the done acknowledge conductor 334, it may de-assert the completion signal on the done request conductor 328. When publishing circuit 310 detects the de-assertion of the completion signal, it may de-assert the acknowledge signal on the done acknowledge conductor 334. Once publishing circuit 310 de-asserts the acknowledge signal on the done acknowledge conductor 334, it is cleared for handling the next event, and it may issue a new request signal on request conductor 320. If any events occurred prior to being cleared for handling the next event, publishing circuit 310 may queue the event information and start the event notification process described above as soon as the last event is cleared.

Publishing circuit 335 may be substantially the same as publishing circuit 310, but the subscribing DMA circuit may be on a different clock domain. In that case, an event manager for the second clock domain becomes the subscribing circuit as the subscribing event manager 340. On the subscribing side of the subscribing event manager 340 will be a subscribing DMA circuit that will handle the event. Accordingly, PRC request 344 is substantially the same as PRC request 322, request conductor 342 is substantially the same as request conductor 320, acknowledge conductor 353 is substantially the same as acknowledge conductor 332, count conductor 346 is substantially the same as count conductor 326, done request conductor 348 is substantially the same as done request conductor 328, done acknowledge conductor 354 is substantially the same as done acknowledge conductor 334, and status conductor 352 is substantially the same as status conductor 330. Synchronization circuit 350 is used to synchronize the signals across the clock domains. Synchronization between two event managers is shown and described in more detail with respect to FIG. 13.

Publishing event manager 355 may be an event manager of a different clock domain that is synchronizing with event manager 305 to provide published events from a publishing circuit on the publishing side of publishing event manager 355. Accordingly, PRC request 366 is substantially the same as PRC request 322, request conductor 364 is substantially the same as request conductor 320, acknowledge conductor 376 is substantially the same as acknowledge conductor 332, count conductor 370 is substantially the same as count conductor 326, done request conductor 372 is substantially the same as done request conductor 328, done acknowledge conductor 378 is substantially the same as done acknowledge conductor 334, status conductor 374 is substantially the same as status conductor 330, and synchronization circuit 362 is substantially the same as synchronization circuit 350.

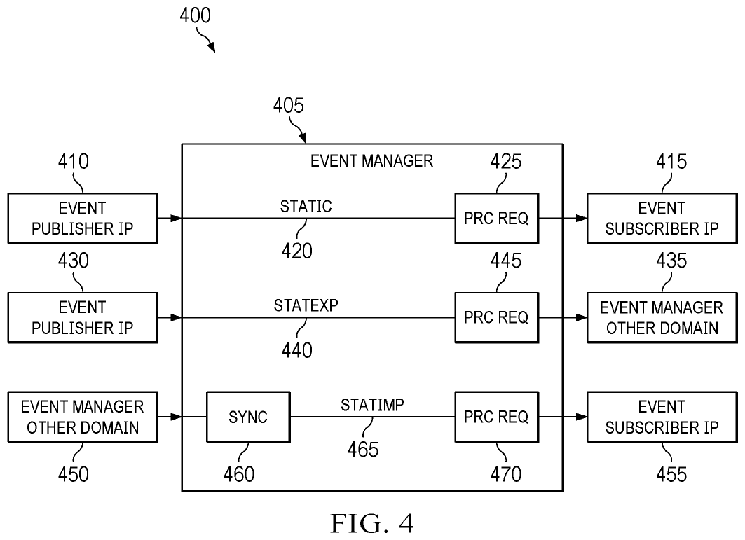

FIG. 4 illustrates exemplary system 400 including event manager 405. Event manager 405 may be substantially the same as event manager 105 but is shown in detail to describe static channels.

System 400 includes publishing circuit 410, publishing circuit 430, publishing event manager 450, event manager 405, subscribing circuit 415, subscribing event manager 435, and subscribing circuit 455.

Publishing circuit 410 may be any circuit used to issue request signal indicating a corresponding event is to be handled by subscribing circuit 415. For example, publishing circuit 410 may be a keyboard input circuit that detects keyboard strokes. Subscribing circuit 415 may be the CPU, an input to a CPU interrupt, or any subscribing circuit that may handle the event associated with the signal from the publishing circuit 410. Event manager 405 provides a point-to-point event channel 420 between publishing circuit 410 and subscribing circuit 415. This may be a static channel configured during manufacturing. Event channel 420 includes two conductors. A first conductor is used by publishing circuit 410 to assert the request signal, indicating the event and that the subscribing circuit 415 is designated to handle the event. A second conductor is used by subscribing circuit 415 to acknowledge the request signal issued by publishing circuit 410. Subscribing circuit 415 asserts the acknowledge signal on the second conductor in response to detecting the assertion of the request signal on the first conductor. Publishing circuit 410 can detect the acknowledge signal on the second conductor. In this way, event channel 420 can provide independent bi-directional communication. Further, when publishing circuit 410 detects the assertion of the acknowledge signal from subscribing circuit 415, publishing circuit 410 can de-assert the request signal on the first conductor. When subscribing circuit 415 detects the de-assertion of the request signal, it can de-assert the acknowledge signal on the second conductor. Once publishing circuit 410 detects the de-assertion of the acknowledge signal, it may issue a new request signal for the next event. Further, PRC request 425 may function the same as PRC request 322 described with respect to FIG. 3. A wakeup circuit (not shown) in or coupled to subscribing circuit 415 may wake up subscribing circuit 415 if it is in a low- or no-power mode.

Publishing circuit 430 may be substantially the same as publishing circuit 410, event channel 440 may be substantially the same as event channel 420, and PRC request 445 may be substantially the same as PRC request 425. Subscribing event manager 435 may be used if the subscribing circuit is on a different clock domain than publishing circuit 430. In that case, an event manager for the second clock domain becomes the subscribing circuit as the subscribing event manager 435. On the subscribing side of the subscribing event manager 435 will be a subscribing circuit that will handle the event.

Publishing event manager 450 may be used if the publishing circuit is on a different clock domain than subscribing circuit 455. In that case, an event manager for the second clock domain becomes the publishing circuit as the publishing event manager 450. On the publishing side of the publishing event manager 450 will be a publishing circuit that will detect the event and assert the request signal. Event channel 465 may be substantially the same as event channel 420, PRC request 470 may be substantially the same as PRC request 445, and subscriber circuit 455 may be substantially the same subscriber circuit 415. Synchronization circuit 460 may be substantially the same as synchronization circuit 350 as described with respect to FIG. 3. Synchronization between two event managers is shown and described in more detail with respect to FIG. 13.

FIG. 5 illustrates an exemplary graph 500 depicting the clock signal 505, the request signal 510, and the acknowledge signal 515 to show how the four-way handshake between publishing circuits (e.g., publishing circuits 110) and subscribing circuits (e.g., subscribing circuits 135) is completed.

Clock signal 505 indicates the clock for a clock domain of the event manager. Request signal 510 indicates the request signal transmitted on the first conductor from the publishing side input to the subscribing side output of the event channel (e.g., static channel 140, generic channel 145, DMA channel 150). Acknowledge signal 515 indicates the acknowledge signal transmitted on the second conductor from the subscribing side input to the publishing side output of the event channel (e.g., static channel 140, generic channel 145, DMA channel 150). As discussed throughout, the depicted channels allow for bi-directional communication using at least two conductors and can each be thought of as having a request conductor (i.e., first conductor) and an acknowledge conductor (i.e., second conductor).

In use, an event may occur indicating to the publishing circuit to assert the request signal 510 on the first conductor of the event channel, which is asserted at time 520. The subscribing circuit detects the assertion of the request signal 510 and, at time 525, asserts the acknowledge signal 515 on the second conductor of the event channel in response. The publishing circuit detects the assertion of the acknowledge signal 515 and, at time 530, de-asserts the request signal 510 in response. The subscribing circuit detects the de-assertion of the request signal 510 and, at time 535, de-asserts the acknowledge signal 515 in response. When both the request signal 510 and the acknowledge signal 515 are de-asserted (after time 535), the publishing circuit can assert a new request signal for the next event. Between time 520 to time 535, if an event occurs, the publishing circuit may put the event information in a queue until the lines are clear again (at time 535) to issue a new request signal. In this way, events are not missed, and all events are handled by the subscribing circuit.

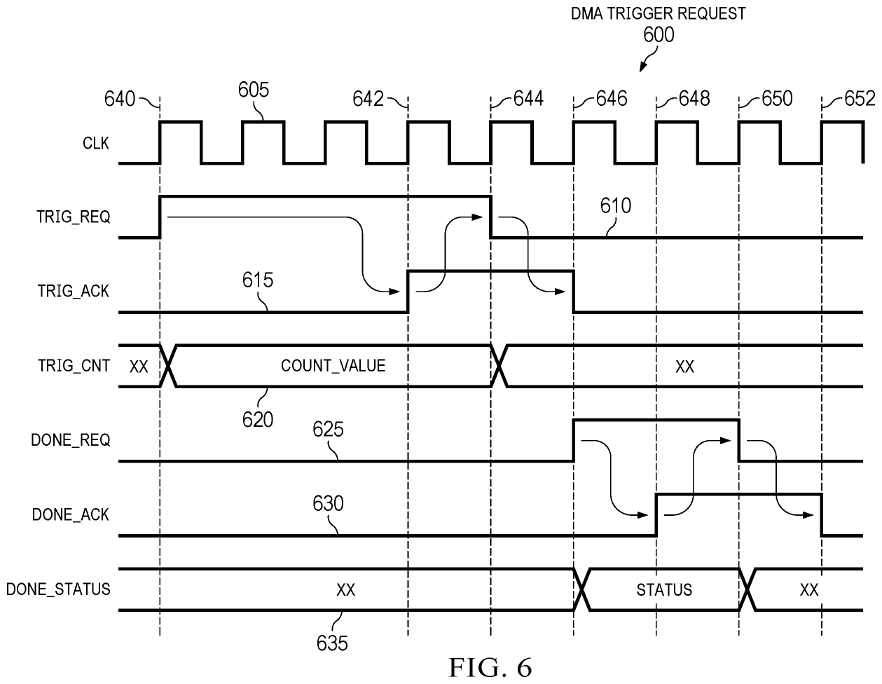

FIG. 6 illustrates an exemplary graph 600 depicting the clock signal 605, the request signal 610, the acknowledge signal 615, the count signal 620, the done request signal 625, the done acknowledge signal 630, and the status signal 635 to show how the four-way handshake is used for DMA channels more specifically than was shown in graph 500.

Clock signal 605 indicates the clock for a clock domain of the event manager. Request signal 610 indicates the request signal transmitted on the first conductor from the publishing side input to the subscribing side output of the event channel (e.g., DMA channel 150). Acknowledge signal 615 indicates the acknowledge signal transmitted on the second conductor from the subscribing side input to the publishing side output of the event channel (e.g., DMA channel 150). As discussed throughout, the depicted channels allow for bi-directional communication using a number of conductors.

Count signal 620 indicates a count value transmitted on a third conductor of the event channel that provides the number of DMA transactions to be performed by the subscribing circuit with respect to the current request signal 610.

Done request signal 625 indicates the completion signal transmitted on the fourth conductor from the subscribing side input to the publishing side output of the event channel. Done acknowledge signal 630 indicates the completion (or done) acknowledge signal transmitted on the fifth conductor from the publishing side input to the subscribing side output of the event channel.

Status signal 635 indicates the status of the DMA transaction processing, which is transmitted on the sixth conductor in the event channel from the subscribing circuit to the publishing circuit.

In use, an event may occur indicating to the publishing circuit to assert the request signal 610 on the first conductor of the event channel. The request signal 610 is asserted at time 640. The subscribing circuit detects the assertion of the request signal 610 and, at time 642, asserts the acknowledge signal 615 on the second conductor of the event channel in response. The subscribing circuit also begins processing the DMA transactions based on the number indicated in the count signal 620 transmitted on the third conductor of the event channel. The publishing circuit detects the assertion of the acknowledge signal 615 and. At time 644, de-asserts the request signal 610 in response. The subscribing circuit detects the de-assertion of the request signal 610 and, at time 646, de-asserts the acknowledge signal 615 in response. This completes the event signal four-way handshake, which is the same as that described with respect to graph 500.

Meanwhile, the subscribing circuit may have been processing the DMA transactions since time 642 when it detected the assertion of the interrupt signal 610. When the subscribing circuit is done processing the DMA transactions, it asserts the completion signal 625 on the fourth conductor of the event channel. This happens at time 646. While time 646 corresponds with the de-assertion of the acknowledge signal 615 on the second conductor, the timing may be different in various examples. The publishing circuit may detect the assertion of the completion signal 625 and, at time 648, assert the done acknowledge signal 630 on the fifth conductor of the event channel in response. The subscribing circuit may detect the assertion of the done acknowledge signal 630 and, at time 650, de-assert the completion signal 625 in response. The publishing channel may detect the de-assertion of the completion signal 625 and, at time 652, de-assert the done acknowledge signal 630 in response. This completes the processing complete four-way handshake. At this time, the publishing circuit may transmit a new request signal for the next event, which may have been queued if it occurred after time 640 and before time 652. In some embodiments, a new request signal may be transmitted after time 646 when both the request signal 610 and acknowledge signal 615 are de-asserted, and the subscribing circuit may queue the event for processing after time 652 when the first event is done processing. These four-way handshakes ensure events are handled without loss even if a next event occurs in rapid succession because the publishing circuit knows, based on receiving the acknowledge signal 615 and the de-assertion of the acknowledge signal 615, that the subscribing circuit has received the event before issuing a second event request signal.

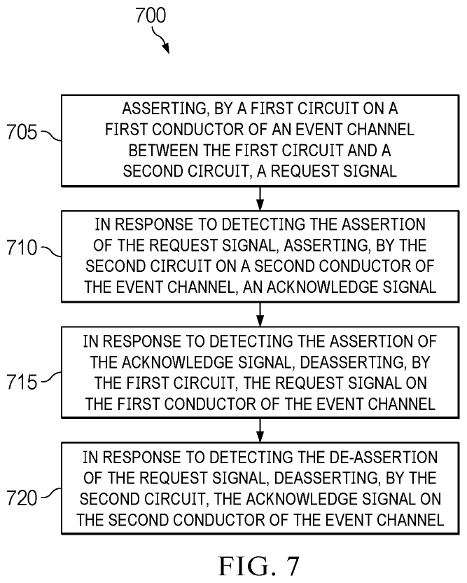

FIG. 7 illustrates a method 700 for completing a four-way event handshake. Method 700 may be performed by a system including system 100, system 200, system 300, or system 400 and specifically by publishing circuits and subscribing circuits of the systems. Method 700 begins as 705 with a first circuit asserting a request signal on a first conductor of an event channel between the first circuit and the second circuit. For example, publishing circuit 210 may assert a request signal using the first conductor of event channel 225a, which subscribing circuit 235 subscribes to. This is seen at time 520 on request signal 510 shown in graph 500 of FIG. 5 and at time 640 on request signal 610 shown in graph 600 of FIG. 6.

At 710, the second circuit may detect the assertion of the request signal and, in response, assert an acknowledge signal on a second conductor of the event channel. For example, subscribing circuit 235 may detect the assertion of the request signal at the output of the first conductor of the event channel 225a and, in response, assert the acknowledge signal on the second conductor of the event channel 225a. This is seen at time 525 on acknowledge signal 515 shown in graph 500 of FIG. 5 and at time 642 on acknowledge signal 615 shown in graph 600 of FIG. 6.

At 715, the first circuit may detect the assertion of the acknowledge signal and, in response, de-assert the request signal on the first conductor of the event channel. For example, publishing circuit 210 may detect the assertion of the acknowledge signal on the second conductor of event channel 225a and, in response, de-assert the request signal on the first conductor of event channel 225a. This is seen at time 530 on request signal 510 shown in graph 500 of FIG. 5 and at time 644 on request signal 610 shown in graph 600 of FIG. 6.

At 720, the second circuit may detect the de-assertion of the request signal and, in response, de-assert the acknowledge signal on the second conductor of the event channel. For example, subscribing circuit 235 may detect the de-assertion of the request signal on the first conductor of the event channel 225a and, in response, de-assert the acknowledge signal on the second conductor of the event channel 225a. This is seen at time 535 on acknowledge signal 515 shown in graph 500 of FIG. 5 and at time 646 on acknowledge signal 615 shown in graph 600 of FIG. 6.

This completes the four-way event signal handshake, so the publishing circuit knows that it may assert a new request signal, and the subscribing circuit will not miss the event.

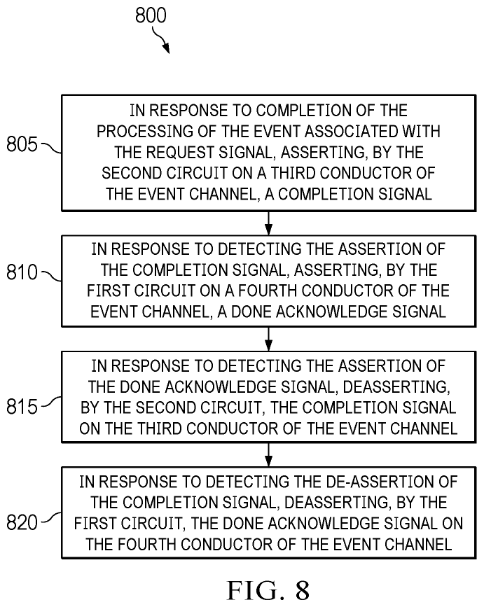

FIG. 8 illustrates a method 800 for completing a four-way processing complete handshake. Method 800 may be performed by a system including system 100 or system 300 and specifically by publishing circuits and subscribing circuits over DMA channels of the systems. Method 800 may be performed after method 700 to provide a processing complete handshake after DMA transactions are processed. Method 800 begins as 805 with the second circuit asserting a completion signal on a third conductor of the event channel between the first circuit and the second circuit. For example, subscribing DMA circuit 315 may assert a completion signal using the done request conductor 328. This is seen at time 646 on done request signal 625 shown in graph 600 of FIG. 6.

At 810, the first circuit may detect the assertion of the completion signal and, in response, assert a done acknowledge signal on a fourth conductor of the event channel. For example, publishing circuit 310 may detect the assertion of the completion signal at the output on the publishing side of done request conductor 328 and, in response, assert the acknowledge signal using the input of the publishing side of the corresponding done acknowledge conductor (not shown). This is seen at time 648 on done acknowledge signal 630 shown in graph 600 of FIG. 6.

At 815, the second circuit may detect the assertion of the done acknowledge signal on the fourth conductor of the event channel and, in response, de-assert the completion signal on the third conductor of the event channel. For example, subscribing DMA circuit 315 may detect the assertion of the acknowledge signal at the output on the subscribing side of the done acknowledge conductor and, in response, de-assert the completion signal. This is seen at time 650 on done request signal 625 shown in graph 600 of FIG. 6.

At 820, the first circuit may detect the de-assertion of the completion signal and, in response, de-assert the acknowledge signal on the fourth conductor of the event channel. For example, publishing circuit 310 may detect the de-assertion of the completion signal at the output on the publishing side of done request conductor 328 and, in response, de-assert the done acknowledge signal. This is seen at time 652 on done acknowledge signal 630 shown in graph 600 of FIG. 6.

This completes the four-way processing complete handshake, so the publishing circuit knows that it may assert a new DMA request signal, and the subscribing circuit will not miss the event and will be able to process the event.

FIG. 9 illustrates a system 900 that includes dynamically configurable generic channels in an event manager (e.g., event manager 105 or event manager 205). System 900 shows an example implementation of the system. Publishing circuit 910 may be substantially the same as publishing circuit 210, subscribing circuit 915 may be substantially the same as subscribing circuit 235, and event manager 905 may be substantially the same as event manager 205. Publishing channel selection signal 930 is used to select the channel for the publishing circuit 910, which is discussed in more detail with respect to FIG. 10. For example, publishing circuit 910 may select the first channel. When publishing circuit 910 issues a request signal 935, the distributed multiplexer 920 identifies the correct channel (e.g., channel 1 in this example), and uses the correct conductor, in this case channel 1 request conductor 940, which subscribing circuit 915 is monitoring to detect the assertion of the request signal. In response, subscribing circuit 915 may assert an acknowledge signal on the corresponding channel 1 acknowledge conductor 945, which is received by the standard multiplexer 925 and transmitted to publishing circuit 910.

FIG. 10 illustrates a system 1000 for configuring generic channels using channel locking in an event manager (e.g., event manager 105 or event manager 205). Channel configuration may be done at system startup or at other times based on software behavior. For example, a publishing circuit may no longer need a channel and may release the channel, and another channel may desire a channel and may be assigned the released channel based on the process discussed with respect to this figure.

System 1000 includes event fabric 1005 of an event manager. The event fabric 1005 may be the event manager or may represent a portion of the event manager. System 1000 further includes publishing circuit connection 1010, publishing circuit connection 1020, and publishing circuit connection 1030. Each of publishing circuit connections 1010, 1020, and 1030 are coupled to a publishing circuit that uses a channel to publish request signals to a subscriber. Publishing circuit connection 1010 is coupled to one hot encoder 1015, publishing circuit connection 1020 is coupled to one hot encoder 1025, and publishing circuit connection 1030 is coupled to one hot encoder 1035. The one hot encoders 1015, 1025, and 1035 help ensure that when a channel is taken, it cannot be selected by a different set of publishing circuit(s) and subscribing circuit(s). For example, publishing circuit connection 1010 may receive a request for a channel from a first publishing circuit and transmit the signal through one hot encoder 1015 to event fabric 1005. As long as the first channel is not yet taken, the first channel is associated with the first publishing circuit. To assign the channel, the first channel line from each one hot encoder is OR'ed to determine if one of the other encoders is using the channel. Since none are, the result is positive. Once the first channel is assigned to the first circuit, a channel lock indicator is accomplished by using the channel taken indicator with the one hot encoder 1040 to enable or lock the channel. The flop 1045 is used to track when a given channel has two assigned subscribing circuits. Once the channel is assigned to the publishing circuit, the subscribing circuit is notified of the channel to use. Continuing the example, publishing circuit connection 1030 may receive a request for a channel from a second publishing circuit and transmit the signal through one hot encoder 1035 to event fabric 1005. The first channel is taken by the first publishing circuit, so request for the first channel will fail. The second channel, not yet taken, will then be assigned to the second publishing circuit associated with publishing circuit connection 1030. A similar process may happen when publishing circuit connection 1020 receives a request from a third publishing circuit for a channel such that the signal is sent to event fabric 1005 via one hot encoder 1025, and since the first two channels are taken, the third channel will be assigned. These one hot encoders 1015, 1025, and 1035 are used in the event fabric 1005 to control the distributed multiplexer (e.g., distributed multiplexer 920).

FIG. 11 illustrates a system 1100 implementing reuse modules in the publishing and subscribing circuits to implement the event manager. Event manager 1105 may be substantially the same as event managers 105, 205, 305, 405, 905, and 1005. Publishing circuit 1110 may be substantially the same as publishing circuits 110, 210, 310, 335, 355, 410, 430, 450, or 910. Subscribing circuit 1115 may be substantially the same as subscribing circuits 135, 235, 315, 340, 360, 415, 435, 455, or 915. Publishing circuit 1110 may include a reuse module 1120 that includes the publishing components (e.g., publishing components 115) used to interact with event manager 1105 as a publisher. Subscribing circuit 1115 may include reuse module 1125 that includes the subscribing components (e.g., subscribing components 130) used to interact with event manager 1105 as a subscriber. These reuse modules 1120, 1125 are used to make incorporation of new publishing and subscribing circuits more streamlined.

FIG. 12 illustrates a system 1200 for configuring event splitting in an event manager 1205 and a corresponding graph 1250 showing the behavior of the request conductor 1225, the first split request conductor 1230, the second split request conductor 1235, the first acknowledge conductor 1240, the second acknowledge conductor 1245, and the publisher acknowledge conductor 1247.

System 1200 includes event manager 1205, publishing circuit 1210, subscribing circuit 1215, and subscribing circuit 1220. Event manager 1205 may be substantially the same as event manager 105, 205, 305, 405, 905, 1005, or 1105. Publishing circuit 1210 may be substantially the same as publishing circuit 110, 210, 310, 355, 355, 410, 430, 450, 910, or 1110. Subscribing circuits 1215 and 1220 may be substantially the same as subscribing circuit 135, 235, 315, 34, 360, 415, 435, 455, 915, or 1115.

As shown in FIG. 12, system 1200 includes publishing circuit 1210 and two subscribing circuits 1215 and 1220, each of which subscribe to publishing circuit 1210. The event is “split” so that both subscribing circuits 1215 and 1220 receive the event at substantially the same time. The event manager 1205 selectively couples the publishing circuit 1210 to subscribing circuits 1215 and 1220 using multiplexers based on the subscribing channel identifiers of the two subscribing circuits 1215 and 1220 matching the publishing channel identifier of the publishing circuit 1210. So, when they match, the publishing circuit 1210 is coupled to both subscribing circuits 1215 and 1220 as shown. Publishing circuit 1210 may issue the request signal 1260 on the request conductor 1225. Request conductor 1225 splits into two request conductors, first split request conductor 1230 and second split request conductor 1235. Subscribing circuit 1215 may detect the request signal on first split request conductor 1230 while subscribing circuit 1220 may detect the request signal on second split request conductor 1235.

Subscribing circuit 1215 may assert an acknowledge signal 1265 on first acknowledge conductor 1240. Subscribing circuit 1220 may assert an acknowledge signal 1270 on second acknowledge conductor 1245. First acknowledge conductor 1240 and second acknowledge conductor 1245 are merged into a final acknowledge signal 1275 on publisher acknowledge conductor 1247. As shown in graph 1250, to generate final acknowledge signal 1275, the acknowledge signal 1265 and acknowledge signal 1270 are AND'ed together while the request signal 1260 is asserted, but they are OR'ed together after the request signal 1260 is de-asserted at time 1255. This ensures that the request signal is not de-asserted until both subscribing circuits 1215 and 1220 have acknowledged the request signal 1260, and it assures that the final acknowledge signal 1275 is not de-asserted on publisher acknowledge conductor 1247 until both subscribing circuits 1215 and 1220 have de-asserted the acknowledge signals 1265 and 1270.

FIG. 13 illustrates a system 1300 for event synchronization across clock domains. System 1300 includes event manager 1302, event manager 1304, publishing circuit 1310, publishing circuit 1317, subscribing circuit 1315, and subscribing circuit 1312. Event managers 1302 and 1304 may be substantially the same as event manager 105, 205, 305, 405, 905, 1005, 1105, or 1205. Publishing circuits 1310 and 1317 may be substantially the same as publishing circuit 110, 210, 310, 355, 355, 410, 430, 450, 910, 1110, or 1210. Subscribing circuits 1312 and 1315 may be substantially the same as subscribing circuit 135, 235, 315, 34, 360, 415, 435, 455, 915, 1115, 1215, or 1220.

Event manager 1302, publishing circuit 1310, and subscribing circuit 1312 may be on a first clock domain, and event manager 1304, subscribing circuit 1315, and publishing circuit 1317 may be on a second clock domain. Publishing circuit 1310 may seek to publish request signals to subscribing circuit 1315. Publishing circuit 1317 may seek to publish request signals to subscribing circuit 1312. Accordingly, event manager 1302 may be a publishing circuit to event manager 1304 and event manager 1304 may be a subscribing circuit to event manager 1302 when publishing circuit 1310 asserts request signals for subscribing circuit 1315. Event manager 1304 may be a publishing circuit to event manager 1302 and event manager 1302 may be a subscribing circuit to event manager 1304 when publishing circuit 1317 asserts request signals for subscribing circuit 1312. In this way, the event managers 1302 and 1304 may transmit the request signals and acknowledge signals across clock domains for the publishing circuit 1310 and subscribing circuit 1315, allowing the four-way handshake to work and avoid having the CPU required to clear the request signals.

Synchronization is handled between the event managers 1302 and 1304. The request signal will be synchronized on the subscriber facing event manager instance. For example, between publishing circuit 1310 and subscribing circuit 1315, synchronization for request signals happens on event manager 1304 at synchronization 1320. Synchronization for the acknowledge signals occurs on the publisher facing event manager instance. For example, between publishing circuit 1310 and subscribing circuit 1315, synchronization for acknowledge signals happens on event manager 1302 at synchronization 1322.

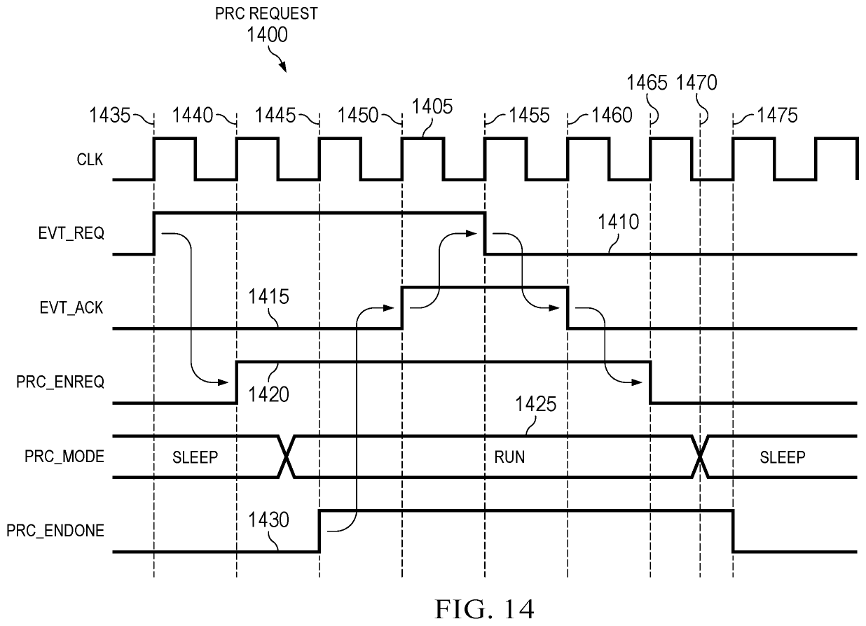

FIG. 14 illustrates a graph 1400 depicting the clock 1405, request signal 1410, acknowledge signal 1415, power reset clock (PRC) request signal 1420, the PRC mode signal 1425, and the PRC done signal 1430. Graph 1400 illustrates the exchange of information for wake up when a subscribing circuit is in a no- or low-power mode, and a wakeup circuit starts the subscribing circuit for detecting the request signal.

At time 1435, the request signal 1410 is asserted. However, as shown by PRC mode signal 1425, the subscribing circuit is sleeping. PRC mode signal 1425 may be an input from a wakeup circuit to the event manager. At time 1440, in response to the request signal 1410, the PRC request signal 1420 is asserted. This triggers the wakeup circuit to start or wake the subscribing circuit. Once the subscribing circuit is running, the PRC done signal 1430 is asserted at time 1445. Once awake, the subscribing circuit will detect and acknowledge the request signal 1410 by asserting the acknowledge signal 1415 at time 1450. The publishing circuit may detect the acknowledge signal 1415 and, in response, de-assert the request signal 1410 at time 1455. The subscribing circuit may detect the de-assertion of the request signal 1410 and de-assert the acknowledge signal 1415 at time 1460. The event manager may detect the de-assertion of the acknowledge signal 1415 and, in response, de-assert the PRC request signal 1420 at time 1465. At time 1470, the subscribing circuit may go back to sleep or into the low- or no-power mode as shown by PRC mode signal 1425. The wakeup circuit may detect that the subscribing circuit is sleeping again and de-assert the PRC done signal 1430 indicating the subscribing circuit is asleep to align with the PRC mode signal 1425 at time 1475.

While some examples provided herein are described in the context of an SoC it should be understood that the subsystems and other systems and methods described herein are not limited to such embodiments and may apply to a variety of other processes, systems, applications, devices, and the like. As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A processing device, comprising:
an event manager coupled between a first circuit and a second circuit, the event manager comprising:
an event channel;
the first circuit configured to:
assert a request signal via the event channel based on detecting an event, and
in response to detecting an assertion of an acknowledge signal, de-assert the request signal; and
the second circuit configured to:
in response to detecting the assertion of the request signal, assert the acknowledge signal via the event channel, and
in response to detecting the de-assertion of the request signal, de-assert the acknowledge signal.

2. The processing device of claim 1, wherein:
the event channel comprises a plurality of conductors, and each conductor of the plurality of conductors is used to transmit a specific type of signal between the first circuit and the second circuit.

3. The processing device of claim 1, wherein the second circuit is further configured to begin processing the event.

4. The processing device of claim 3, wherein:
the second circuit is further configured to:
in response to completion of the processing of the event, assert a completion signal via the event channel, and
in response to detecting an assertion of a done acknowledge signal, de-assert the completion signal; and
the first circuit is further configured to:
in response to detecting the assertion of the completion signal, assert the done acknowledge signal via the event channel, and
in response to detecting the de-assertion of the completion signal, de-assert the done acknowledge signal.

5. The processing device of claim 1, wherein:
the first circuit is further configured to:
transmit a count of a number of DMA transactions associated with the request signal via the event channel; and
the second circuit is further configured to:
in response to detecting the assertion of the request signal and the count, begin processing the number of DMA transactions indicated by the count.

6. The processing device of claim 5, wherein:
the second circuit is further configured to:
in response to completion of the processing of the number of the DMA transactions, assert a completion signal via the event channel, and
in response to detecting an assertion of a done acknowledge signal, de-assert the completion signal; and
the first circuit is further configured to:
in response to detecting the assertion of the completion signal, assert the done acknowledge signal via the event channel, and
in response to detecting the de-assertion of the completion signal, de-assert the done acknowledge signal.

7. The processing device of claim 6, wherein:
the second circuit is further configured to:
in response to completion of the processing of the number of the DMA transactions, assert a done status signal via the event channel, and
in response to de-asserting the completion signal, de-assert the done status signal.

8. The processing device of claim 1, the first circuit further configured to:
detect an event prior to detecting the assertion of the acknowledge signal via the event channel, wherein the first circuit is configured to generate a second request signal based on detecting the event;
store information for generating the second request signal in a queue; and
in response to detecting the assertion of the acknowledge signal via the event channel and de-asserting the request signal via the event channel, assert the second request signal via the event channel.

9. The processing device of claim 1, further comprising a wakeup circuit coupled to the second circuit and configured to:
in response to detecting the assertion of the request signal via the event channel, enable the second circuit from a sleep state to an enabled state that allows the second circuit to detect the assertion of the request signal.

10. The processing device of claim 1, wherein:
the event manager selectably couples the first circuit to the second circuit and a third circuit;
the third circuit is configured to:
in response to detecting the assertion of the request signal via the event channel, assert, via the event channel, a second acknowledge signal to the first circuit; and
the first circuit de-asserting the request signal is further in response to detecting both the acknowledge signal and the second acknowledge signal.

11. The processing device of claim 1, wherein the event manager is configured to:
dynamically assign each of a plurality of event channels between one of a plurality of publishing circuits and an associated subscribing circuit of a plurality of subscribing circuits, wherein the event channel is a first event channel of the plurality of event channels, the first circuit is a first publishing circuit of the plurality of publishing circuits, and the second circuit is a first subscribing circuit of the plurality of subscribing circuits.

12. A method comprising:
asserting, by a first circuit over an event channel between the first circuit and a second circuit, a request signal;
in response to detecting the assertion of the request signal, asserting, by the second circuit over the event channel, an acknowledge signal;
in response to detecting the assertion of the acknowledge signal, de-asserting, by the first circuit, the request signal; and
in response to detecting the de-assertion of the request signal, de-asserting, by the second circuit, the acknowledge signal.

13. The method of claim 12, wherein the event channel comprises a plurality of conductors, and each conductor of the plurality of conductors is used to transmit a specific type of signal between the first circuit and the second circuit.

14. The method of claim 12, further comprising:
in response to detecting the assertion of the request signal, beginning, by the second circuit, processing an event associated with the request signal;
in response to completion of the processing of the event associated with the request signal, asserting, by the second circuit over the event channel, a completion signal;
in response to detecting the assertion of the completion signal, asserting, by the first circuit over the event channel, a done acknowledge signal;
in response to detecting the assertion of the of the done acknowledge signal, de-asserting, by the second circuit, the completion signal; and
in response to detecting the de-assertion of the completion signal, de-asserting, by the first circuit, the done acknowledge signal.

15. The method of claim 12, further comprising:
transmitting, by the first circuit, a count of a number of direct memory access (DMA) transactions associated with the request signal over the event channel; and
in response to detecting the assertion of the request signal and the count, beginning, by the second circuit, processing the number of the DMA transactions indicated by the count.

16. The method of claim 15, further comprising:
in response to completion of the processing of the number of the DMA transactions, asserting, by the second circuit over the event channel, a completion signal;
in response to detecting the assertion of the completion signal, asserting, by the first circuit over the event channel, a done acknowledge signal;
in response to detecting the assertion of the of the done acknowledge signal, de-asserting, by the second circuit, the completion signal; and
in response to detecting the de-assertion of the completion signal, de-asserting, by the first circuit, the done acknowledge signal.

17. The method of claim 16, further comprising:
asserting, by the second circuit over the event channel between the first circuit and the second circuit, a done status signal in response to completion of the processing of the number of the DMA transactions; and
de-asserting, by the second circuit, the done status signal in response to de-asserting the completion signal.

18. The method of claim 12, further comprising:
detecting, by the first circuit, an event configured to generate a second request signal prior to detecting the assertion of the acknowledge signal;
storing, by the first circuit, information for generating the second request signal in a queue; and
in response to detecting the assertion of the acknowledge signal via the event channel and de-asserting the request signal via the event channel, asserting, by the first circuit, the second request signal via the event channel.

19. The method of claim 12, wherein the second circuit is in a sleep state, the method further comprising:
in response to detecting the assertion of the request signal via the event channel, enabling, by a wakeup circuit associated with the second circuit, the second circuit from the sleep state to an enabled state that allows the second circuit to detect the assertion of the request signal.

20. The method of claim 12, further comprising:
selectably coupling the first circuit to the second circuit and a third circuit; and
in response to detecting the assertion of the request signal via the event channel, asserting, by the third circuit via the event channel between the first circuit and the third circuit, a second acknowledge signal, wherein the first circuit de-asserting the request signal via the event channel is further in response to detecting both the acknowledge signal and the second acknowledge signal.
